(19) United States
(12) Patent Application Publication
(10) Pub. No.: US 2007/0294231 A1
(43) Pub. Date: Dec. 20, 2007

(54) Viideo library management method and apparatus

(75) Inventor: Takahisa Kaihotsu, Musashino-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/807,702

(22) Filed: May 29, 2007

(30) Foreign Application Priority Data
Jun. 14, 2006 (JP) 2006-165040

(51) Int. Cl. G06F 17/30

(52) U.S. Cl. 707/3

(57) ABSTRACT

According to one embodiment, when a user designates a management method, a folder is added automatically for file management, allowing the user to easily search for a desired file. Basically, a video library management apparatus is provided with a storage section including a plurality of folders, each of which stores files, a folder management section configured to manage the folders of the storage section, and a library management section configured to cause the folder management section to classify and manage the folders based on a folder classification table having a hierarchical structure. When each of the folders contains more than a predetermined number of files, the library management section automatically adds a new folder.

### CROSS-REFERENCE TO RELATED APPLICATIONS

This application is based upon and claims the benefit of priority from Japanese Patent Application No. 2006-165040, filed Jun. 14, 2006, the entire contents of which are incorporated herein by reference.

### BACKGROUND

1. Field

One embodiment of the invention relates to a video library management method and apparatus. When a file is recorded in a recording medium or deleted therefrom, the management method and apparatus according to the embodiment automatically manage files in such a manner that the user can easily understand the state of the files.

2. Description of the Related Art

In recent years, recording mediums such as a hard disk for a hard disc drive (HDD) and digital versatile disks (DVD) have an increased recording capacity, and a recording/playback apparatus employing one of such recording mediums can store a large number of programs by programmed recording.

On the other hand, many types of broadcast system are now available, including terrestrial analog broadcasting, terrestrial digital broadcasting, satellite analog broadcasting, satellite digital broadcasting, etc.

In digital broadcasting, an Electronic Program Guide (EPG) is broadcast as program information, in place of a conventional TV program listing shown on newspapers or magazines, and the feasibility is now being studied as to whether the EPG can be acquired from a network such as a telephone line.

Recent recording/playback apparatuses have a programmed recording function of automatically recording those programs which the user selects beforehand from the program listing. They also have an automatic programmed recording function of permitting the user to designate his or her favorite genre and automatically searching for programs belong to that genre from the program listing.

The greater the storage capacity of a recording medium is, the larger the number of programs (files) which are recorded in the recording medium. While looking at the thumbnails of programs shown on the display, the user searches for a program the user would like to view. However, where many programs (files) are recorded in a recording medium, it takes time to find or locate the program the user would like to view.

To solve these problems, a video recording apparatus that has a number of folders for the management purpose has been developed (see Jpn. Pat. Appln. KOKAI Publication No. 2005-260590). The user of the apparatus designates which folder should be used for recording video data, by operating the operation section. Thus, the user can classify video data according to the folders. To search for desired video data (or a file), the user checks the designated folder and can easily locate the desired video data. However, the apparatus has problems in that the user has to designate a file storage folder beforehand.

### BRIEF DESCRIPTION OF THE SEVERAL VIEWS OF THE DRAWINGS

A general architecture that implements various features of the invention will now be described with reference to the drawings. The drawings and the associated descriptions are provided to illustrate embodiments of the invention and not to limit the scope of the invention.

FIG. 1 is a block diagram illustrating the configuration of a television receiver according to the present invention.

FIG. 2 is a flowchart illustrating an example of how the receiver of FIG. 1 operates.

FIG. 3 is a flowchart illustrating part of the flowchart of FIG. 2 in detail.

FIG. 4 shows EPG information which is an example of a method for obtaining the property of a video file (program).

FIG. 5 is an explanatory diagram showing the initial state of a file classification table.

FIG. 6 illustrates an example of a maximum number of files that can be stored in each folder of the folder classification table.

FIGS. 7A and 7B are explanatory diagrams showing a folder used in the present invention, along with an example of thumbnails of the files stored in that folder.

FIGS. 8A and 8B are explanatory diagrams showing a folder used in the present invention, along with another example of thumbnails of the files stored in that folder.

FIGS. 9A and 9B are explanatory diagrams showing a folder used in the present invention, along with still another example of thumbnails of the files stored in that folder.

FIG. 10 shows an example of the property of video files used in the present invention.

FIG. 11 shows an example of a folder hierarchy used in the present invention.

FIG. 12 is an explanatory diagram showing how the display screen of the apparatus of the present invention switches from one to another.

FIG. 13 is a flowchart showing an example of how the unit of the present invention operates.

### DETAILED DESCRIPTION

Various embodiments according to the present invention will be described hereinafter with reference to the accompanying drawings.

An object according to one aspect of the present invention is to provide a view library management method and apparatus which automatically create a folder for file management in response to the user's designation of a management method, and which thereby permit the user to easily locate a desired file.

To achieve the above object, the one aspect of the present invention provides a video management apparatus comprising: a storage section having a plurality of folders each of which stores files; a folder management section configured to manage the folders of the storage section; and a library management section configured to cause the file management section to manage arrangement of the folders on the basis of a file classification table having a hierarchical structure, and to create a new folder of a lower hierarchy level when the number of files stored in each folder has exceeded a predetermined number.

With the above structure, a plurality of folders are arranged on the basis of a preset classification table. The number of files that can be stored in each folder is limited. An addition or creation means is provided, and when the number of files stored in each folder exceeds a predetermined number, a new folder is automatically created.

The deletion means deletes files, and a folder containing no file is also deleted automatically. Even where many programs are recorded automatically, the user can easily locate a desired file for playback. Although a classification method is designated in the subject apparatus, the creation and classification of folders are automatically performed. The user therefore does not have to designate a folder at the time of programmed recording. The user is only required to designate a video data-saving method at the beginning. The programs recorded thereafter are automatically saved while being classified in hierarchical folders, and the user can easily search for a program he or she needs.

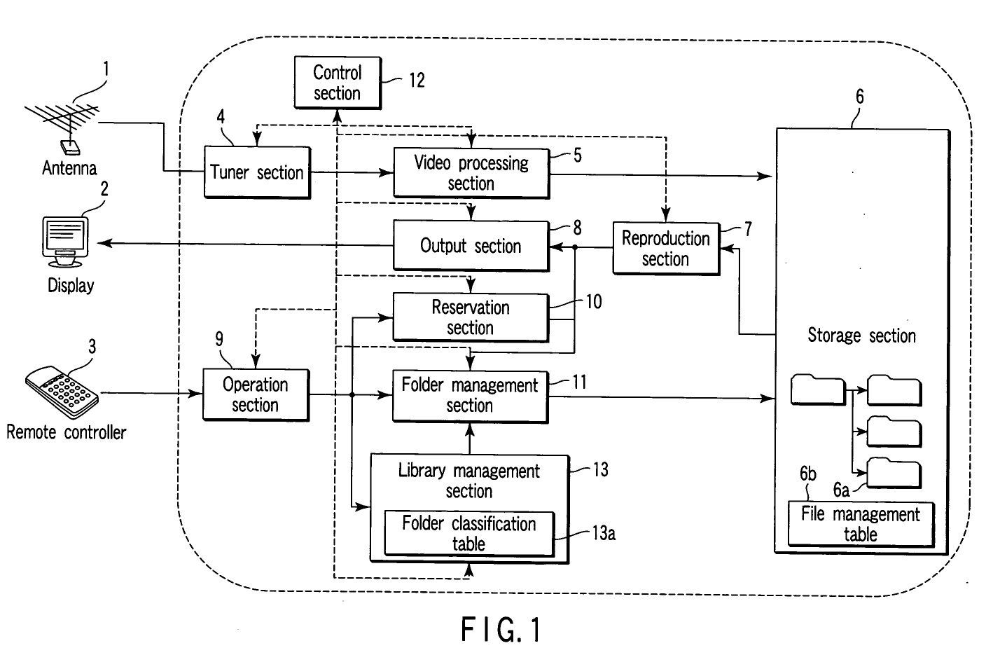

An embodiment of the present invention will now be described in detail with reference to the accompanying drawings. FIG. 1 illustrates a television receiver to which the present application is applied. The present invention is applicable not only to television receivers but also to information recording/playback apparatuses and servers. Reference numeral 1 denotes an antenna connected to a tuner 4. A display 2 is a liquid crystal display or a CRT display and displays video or an operation menu. A remote controller 3 is operated when the user enters data for programmed recording or prepares a folder classification table. The remote controller 3 is provided with: a ten-key pad used for entering G codes or numerals representing times, channels, etc.; an operation button used for designating recording/playback; a cross key used for operating a GUI (graphic user interface). G cods are assigned codes for each pf programs in advance, and the G cods are described on a program guide, for example.

Operation signals supplied from the remote controller 3 are received at an operation section 9 and are then supplied to a control section 12. The control section 12 controls the tuner section 4 in accordance with a tuning operation at the remote controller 3. Based on the control information supplied from the control section 12, the tuner section 4 selects a channel and receives television (TV) broadcast signals. The tuner section 4 selects and receives the television broadcast signals to produce audio and video signals. In the present embodiment, the tuner section 4 is configured to receive and decode terrestrial analog broadcast signals or digital broadcast signals.

A video processing section 5 converts audio and video signals obtained at the tuner section 4 into recording signals (encoding). In the present embodiment, the conversion is based on MPEG2, which is a generally-accepted standard. An MPEG2 video file obtained by the conversion is stored in an storage section 6.

A storage section 6 stores the MPEG2 video file produced by the video processing section 5. The storage section 6 is a hard disk, for example. Needless to say, DVD (digital versatile disk) or HD-DVD (high definition DVD) may be used as the storage section 6.

Video files are managed by use of hierarchal folders 6a. The folder of the highest hierarchical level is referred to as a root folder. Unless designated otherwise, the video files generated by the video processing section 5 are stored in the root folder. The storage section stores a file management table 6b used for managing the attributes of recorded video files.

A reproduction section 7 converts (decodes) video files of the storage section 6 into signals for display. To be more specific, the reproduction section 7 reads out video files (i.e., data compressed based on MPEG2 standard) from the storage section 6 and decodes them for expansion. The decoded video signals are supplied to an output section 8.

The output section 8 blends (or synthesizes) an image obtained at the reproduction section 7 with a program list or an operation menu obtained at a reservation section 10. The blended images are shown on a display 2.

The operation section 9 receives commands supplied from the remote controller 3 (the commands are infrared commands, for example), for operations of the present apparatus. The reservation section 10 manages a program list such as an EPG (electronic program guide) or displays it on the output section 8. Where the user programs the apparatus to record a broadcast program by use of the displayed program list, the information on the programmed recording is managed by the reservation section 10.

The reservation section 10 comprises a program recording reservation table and a timepiece (neither is shown). The program recording reservation table is used for managing recording times, channels, recording modes (standard mode or triple mode), etc. The timepiece is used mainly for timer-controlled recording.

A folder management section 11 manages the folders stored in the storage section. To be more specific, the folder management section 11 creates or deletes folders. Also, the folder management section 11 moves video files, searches for them, or deletes them. In addition, the folder management section 11 manages folder names, names of the video data stored in the folders, and the attributes (property) of the video files. The attributes are specifically the genre of video data acquired from the EPG, a TV station code, an air date, etc. The attributes of the video files are stored in the file management table 6b of the storage section 6.

The control section 12 controls each of the sections of the apparatus, including the reproduction section 7 and the reservation section 10. For example, the control section 12 receives program recording-request signals from the reservation section 10, turns on the tuner section 4, the video processing section 5 and the storage section 6, controls the tuner section 4 to select a reception channel, and controls the video processing section 5, for program recording processing.

A library management section 13 is unique to the present invention and has at least the following two functions:

The first function is to create a folder classification table 13a on the basis of signals input from the operation section 9. To be more specific, the library management section 13 can designate a genre based on which folders are prepared (this designation will be referred to as folder classification). The library management section 13 can also designate how many video files can be stored in each file (the upper limit of the number of files stored in each folder).

The second function is to cause the folder management section 11 to create a new folder on the basis of the folder classification table. By moving video files between the folders and controlling the movement, the video files of the storage section 6 can be classified and stored in accordance with the folder classification table. Folders can be deleted, if necessary.

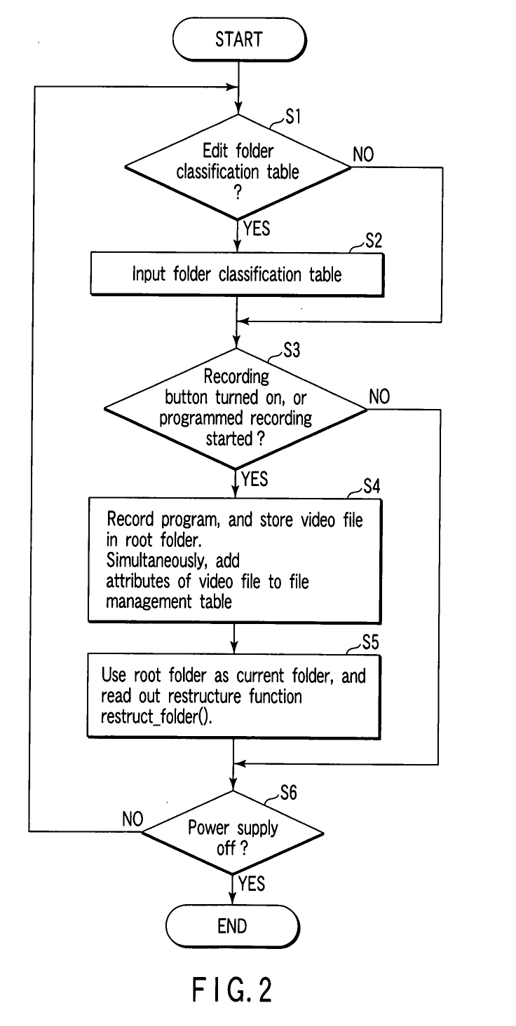

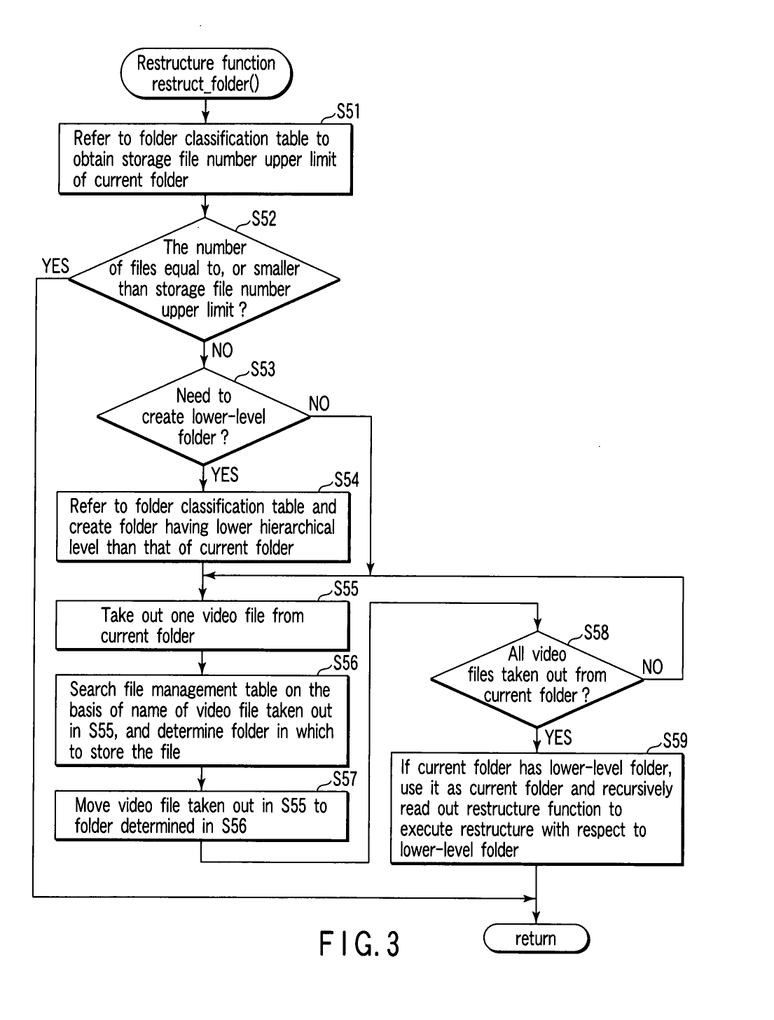

An operation of the above-mentioned apparatus will now be given with reference to FIGS. 2 and 3. FIG. 3 describes details of Step S5 shown in FIG. 2.

Steps S1-S2 will be described, referring to FIG. 2.

In FIG. 2, Steps S1-S2 are the steps in which the folder classification table is edited. The editing processing includes the creation of a folder and the changing of the created folder. In the initial state, the folder classification is defined with respect to the root (reserved word). In the case of the present embodiment, a keyword such as a genre, a sub-genre, a TV station code, or an air date, is defined in connection with the folder classification. The user designates a keyboard with respect to each of the hierarchical folder levels (phases) at which the user would like to classify video files. The genre and sub-genre are based on the genre classification acquired from the known EPG. After determining the folder classification table, the user designates a storage file number upper limit, which is the upper limit of the number of files that can be stored in each folder.

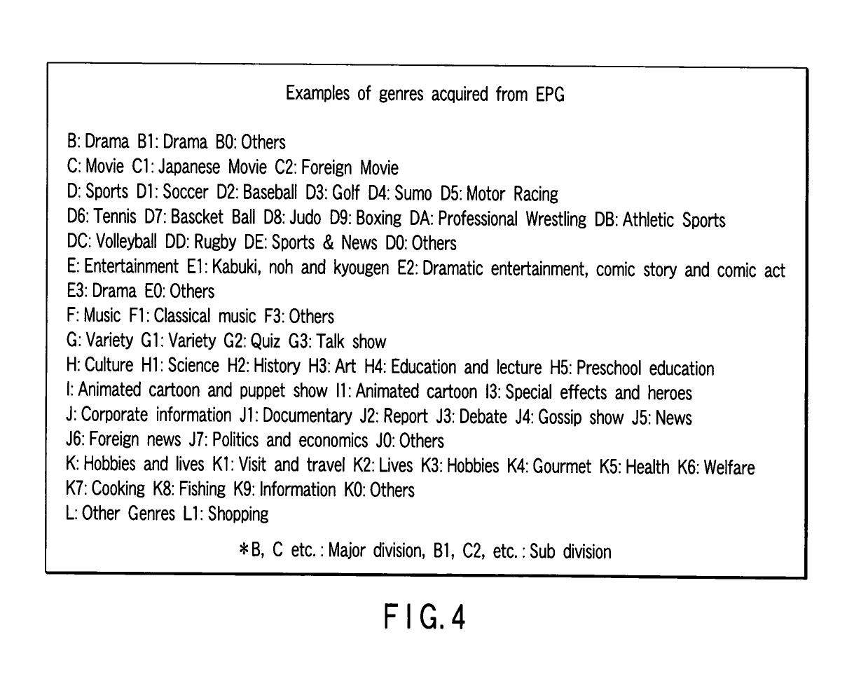

FIG. 4 shows an example of a genre that can be acquired from the EPG. In the EPG, a program genre is represented by use of one alphabetical letter and one numeral. The first alphabetical letter represents a major division, and the next alphabetical letter or numeral represents a sub division. (For example, where the first letter is “C”, the major division is “movie”, and where the next letter is “1”, the sub division is “Japanese movie”.)

Where “genre” is designated as a keyword, folders are created based on the major divisions (such as “drama”, “movie”, “sports”, etc.) in accordance with the need. Where “sub genre” is designated as a keyword, folders are created based on the sub divisions (such as “Japanese movie”, “foreign movie”, “soccer”, “baseball”, etc.), and video files are classified and stored in them.

The “genre” and the “sub genre” can be designated independently. Where they are designated simultaneously, the “sub genre” is designated as a hierarchical level lower than that of the “genre”. In the present embodiment, the TV station code is represented as a channel number for the sake of convenience.

The storage file number upper limit is a parameter based on which it is determined whether classification is required. The storage file number upper limit is designated for each of the folders. When the number of video files stored in a folder exceeds the storage file number upper limit, the classification processing is started.

The storage file number upper limit can be arbitrarily designated from among the numbers which the user thinks are manageable. Preferably, the storage file number upper limit is designated in such a manner that the thumbnails of the files stored in a video library can be displayed on one screen.

FIG. 5 shows an example of a file classification table. In the initial state, only the root is designated in the item of “folder classification”, and none is set in the item of the storage file number upper limit. Where none is set in the item of the storage file number, this means that there is no upper limit of the number of files stored. In other words, video files are accumulated in the root folder every time programs are recorded (that is, the video files are stored in the root folder without being classified).

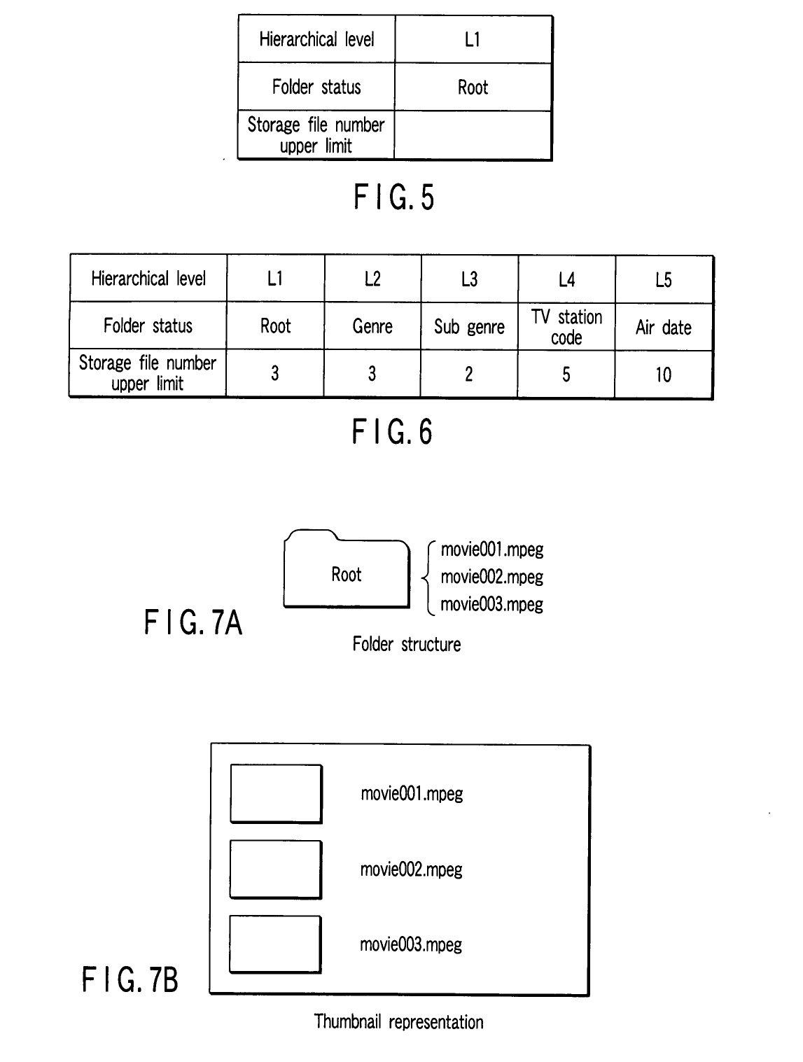

Let us assume that the order of “genre sub→genres→TV station code→air date” is designated from the root, as shown in FIG. 6, and that the storage file number upper limits of the folder classifications are designated as “3→3→2→5→10”. As a result of this designation, when four video files have been stored in the root folder, folders corresponding to the genres such as “drama”, “movie”, “sports”, “entertainment” and “music” are created to store the files, and a video file is moved from the root folder to an appropriate one. (When those folders exist, what is performed is limited to the movement of the video file.)

The user can determine the above-mentioned numbers of files shown in FIG. 6 by operating the remote controller 3. When a menu screen appears on the display 2, the user selects the item of “determine the number of files stored in a folder”, for example. In response to the selection, a table such as that shown in FIG. 6 appears. Then, the user operates the ten-key pad of the remote controller 3 to set the number of files in each blank portion. A file number setting section used then is provided in the library management section 13 and operates in relation to the operation of the control section 12.

Turning back to FIG. 2, the subsequent steps (namely, steps S3 to S5) will be described.

When the recording button and the stop button are depressed in this order, or when programmed recording is executed, a new video file is created (Step S3). The video file is stored first in the root folder of the storage section 6. When it is stored, attributes of the video file are added to the file management table (Step S4). When a new video file is created and the root folder is used as a current folder, the restructuring processing of folders is started (Step S5). (The restructuring processing will be described later.)

In Step S6, the state of the power supply is checked. If the power supply is OFF, the processing is brought to an end. If the power supply is not OFF, the standby mode is kept until the recording button is depressed or the time for programmed recording comes.

The restructuring processing (Step S5) is complicated and will be explained, referring to another Figure (Step 7A). Let us assume that files movie001.mpeg to movie003.mpeg are stored in the root folder in the initial state, as shown in FIG. 7A, and that video files movie004.mpeg to movie010.mpeg are added as a result of the recording of programs. When the files have to be added, the restructuring processing of folders is executed.

FIGS. 7B, 8B and 9B show how the folder structures are displayed as thumbnails. According to the present embodiment, when a folder represented as a thumbnail is selected, video files or folders of the lower hierarchical level are displayed. When a video file represented as a thumbnail is selected and the execution thereof is designated, the video file is played back.

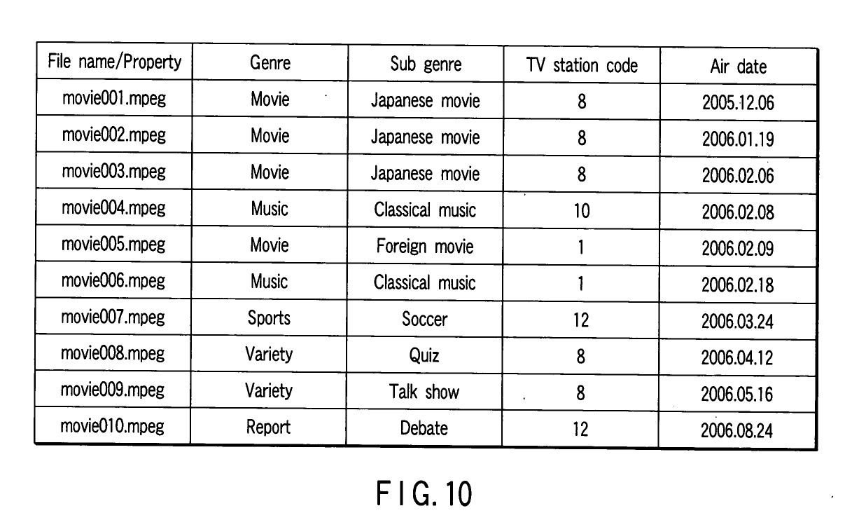

FIG. 10 shows an example of the property (attributes) of video files used in the present invention. In other words, FIG. 10 shows an example of the file management table which is managed by the folder management section 11. The file management stable is referred to when a folder in which video files are to be stored is determined in Step S56 of the flowchart of FIG. 3.

Turning back to FIG. 3, Step S51 and its subsequent Steps will be described.

Step S51: A newly created video file of movie004.mpeg is stored first in the root folder (Step S4). Since three video files, namely movie001.mpeg to movie003.mpeg, exist in the root folder, there are four video files stored in the root folder. In this state, the folder classification table (FIG. 6) in the current folder (root folder) is referred to, thereby obtaining three (3) as the storage file number upper limit.

Step S52: Since the storage file number upper limit of the current (root) folder is three, and the number of files actually stored in the current folder is 4, the control advances to Step S53.

Step S53: Since the root folder is the only folder that exists, the control advances to Step S54, which is a step for preparing a classification folder.

Step S54: Since the folder classification table (FIG. 6) shows that the next hierarchical level of the root folder is related to “genre”, the property of the video files stored in the current (root) folder, namely movie001.mpeg to movie004.mpeg, is examined. As can be seen from the “file management table” shown in FIG. 10, the examination of the property of movie001.mpeg to movie004 leads to the information that the related genres are “movie” and “music”. Since the “movie” and “music” are the genres of the files to be classified, folder “movie” and folder “music” are created as new folders.

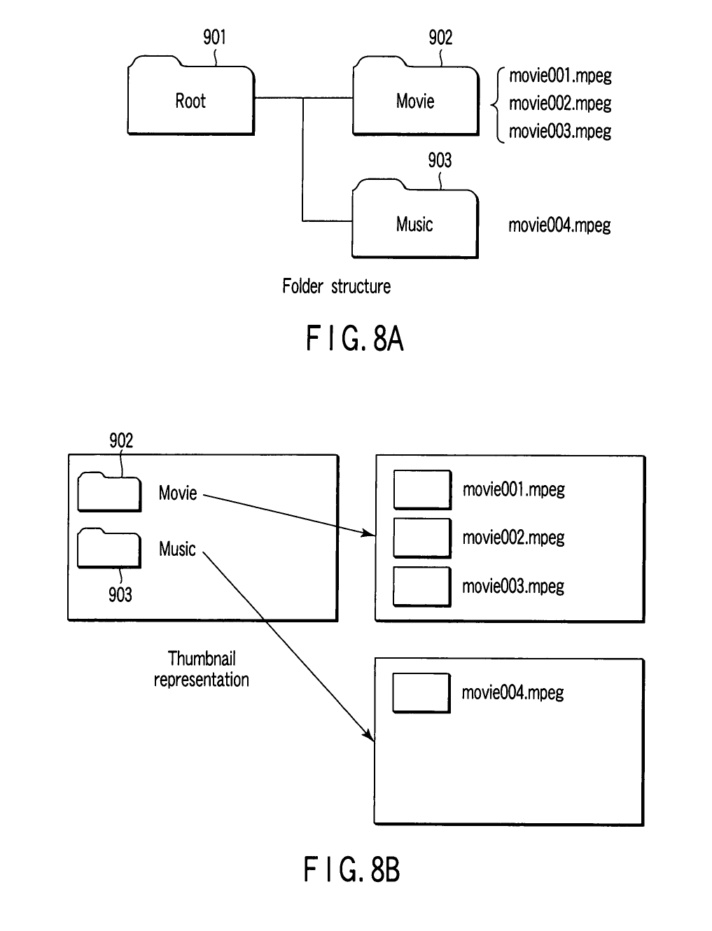

Steps S55 to S58: Video files are taken out one by one from the current (root) folder. The taken-out video files are moved to folders “movie” and “music”, which are at the lower hierarchical level and correspond to the genres of the video files (FIGS. 8A and 8B). After all files have been moved from the current (root) folder, the control advances to Step S59.

Step S59: Since the folders at the lower hierarchical level of the current (root) folder are “movie” and “music” at the time, the current folder is switched to “music”, and Steps S51 to S59 are recursively executed. After this recursive execution, the current folder is switched to “music”, and Steps S51 to S59 are recursively executed. Since only four video files are stored at the time, the recursive execution described above does not create any folder under the “movie” or “music” folder.

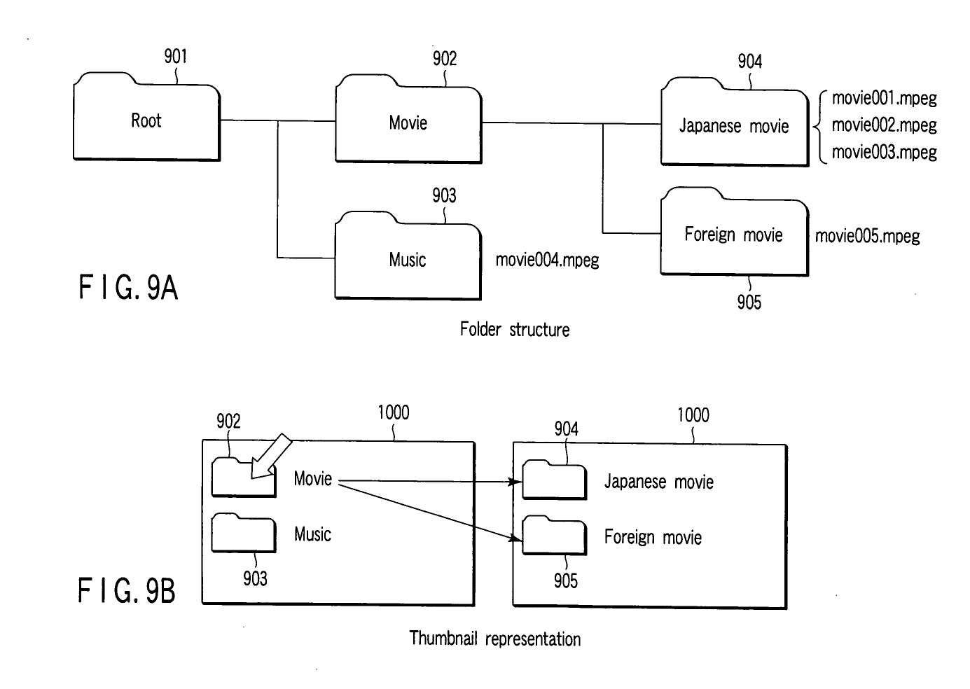

When movie005.mpeg is recorded, the recorded data is stored in the “movie” folder because the genre of that file is “movie”. At this point in time, the number of video files stored in the “movie” folder is 4, which exceeds the storage file number upper limit (=3) of the genre. In this case, a “Japanese movie” folder 904 and a “foreign movie” folder 905 are created under the “movie” folder, and files are moved from the “movie” folder to the “Japanese movie” folder 904 and “foreign movie” folder 905 (FIG. 9A).

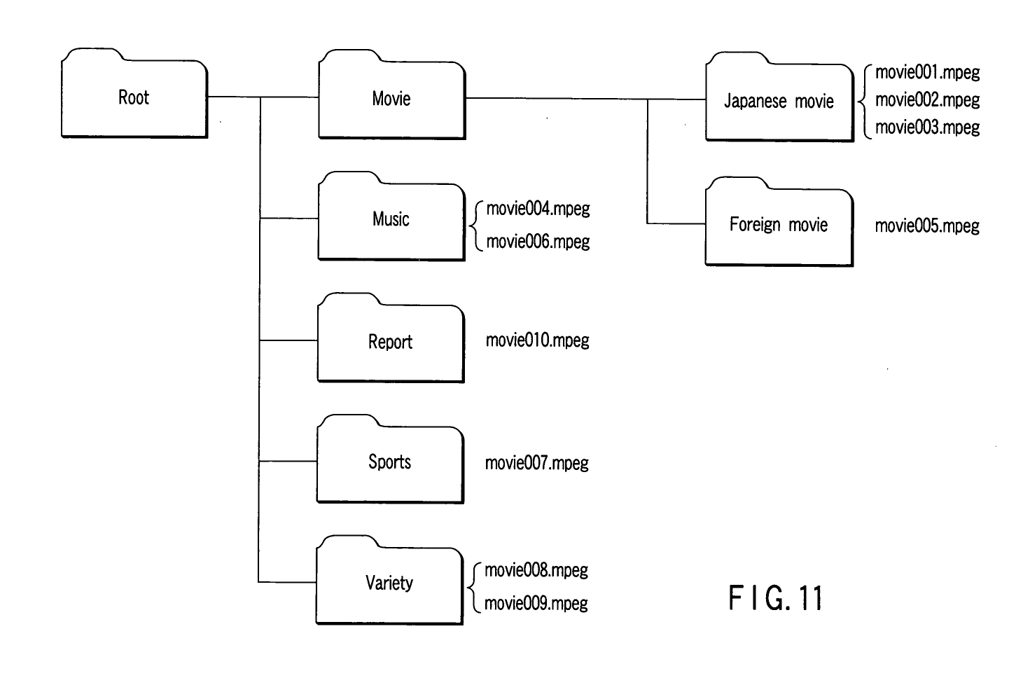

After this control is repeated, ten movie files, namely movie001.mpeg to movie010.mpeg, are classified and stored in the manner shown in FIG. 11. Since the recorded video files are stored in the properly-classified hierarchical folders, the user can search for a desired video file on the basis of the classification he or she determines and from among the video files the number of which he or she determines. In short, the user can easily search for the desired video file.

The above processing will be summarized. As shown in FIG. 6, in the initial setting, the user can limit the number of files stored in each folder to a predetermined number, in such a manner that the maximum number of files stored in the root folder is three (3), the maximum number of files stored in the genre folder is three (3), the maximum number of files stored in the sub genre folder is two (2), etc. A file number input menu used for this purpose is obtained by reading out the folder classification table from the menu screen.

FIGS. 7A, 8B and 9A show that the file of movie001.mpeg, the file of movie002.mpeg and the file of movie 003.mpeg (their genre is “movie”, and their sub genre is “Japanese movie”) are recorded in the root folder 901 in the original state. In this state, the file of movie004.mpeg (the genre is “music program”) is recorded, with the result that a movie folder 902 and a music folder 903 are created. The file of movie001.mpeg, the file of movie002.mpeg and the file of movie003.mpeg are moved to the movie folder, and the file of movie004.mpeg is moved to the newly created music folder 903 (see FIG. 8A). In addition, the file of movie005.mpeg (its genre is “movie”, and its sub genre is “foreign movie”.) is recorded, and folder management is performed in the manner shown in FIG. 9A. At the hierarchical level of the “movie” folder, the maximum number of files that can be stored in a folder is three. When the file of movie005.mpeg is recorded, classification is executed based on the sub genre, and a “Japanese movie” folder 904 and a “foreign movie” folder 905 are created under the “movie” folder 902. The file of movie001.mpeg, the file of movie002.mpeg and the file of movie003.mpeg are moved to the “Japanese movie” folder 904, and the file of movie005.mpeg is stored in the “foreign movie” folder 905. FIG. 9B shows the state where folders 902 and 903 are displayed as icons on the screen 1000 of the display 2. When the user selects a folder 902 by means of a cursor and clicks it, the folders 904 and 905 under the folder 902 appears, as shown.

In the above embodiment, reference was made to the case where the number of folders increases each time a video file is produced by recording. Needless to say, however, editing processing is executed to delete video files. To be more specific, video files that have been viewed and are not necessary are deleted. In this case, video files are moved from a low-level folder to a high-level folder, and the low-level folder is then deleted.

In the embodiment described above, the folders are classified based on “genre”, “sub genre”, “TV station code”, and “air date”. However, the folders may be classified based on “time zone” and “day of the week”, which can be acquired from the system and recorded as attributes. In addition, programs may be designated based on “persons appearing on the program” which can be acquired from the EPG.

The above embodiment was described, referring to the case where terrestrial broadcast signals are received. Needless to say, when the present invention is reduced to practice, satellite broadcasting, the antenna of a cable TV, a tuner, a CATV tuner, etc. may be combined. In addition, although the above embodiment was described referring to the terrestrial analog broadcasting, the present invention is applicable to terrestrial digital broadcasting as well. In this case, video files can be classified based on information which is included in the data broadcasting simultaneous with the program broadcasting and which is related to the contents of programs.

The conventional art enables automatic recording of programs but does not enable automatic classification of recorded programs. There is a conventional apparatus that allows the user to manually manage recorded programs, but what the conventional apparatus can do are limited to the manual creation of folders and manual movement of program files. It is very troublesome to manually perform these operations. In particular, in the case of an HDD recorder incorporating a large-capacity HDD such as a terabyte class HDD, the recording time may be very long and the number of programs that can be stored in the apparatus is very large. When such an HDD recorder is used, it is particularly difficult to search for desired video files. Hence, the present invention is advantageously applied to such a recorder.

A description will now be given of how folder management is performed when a file a deleted.

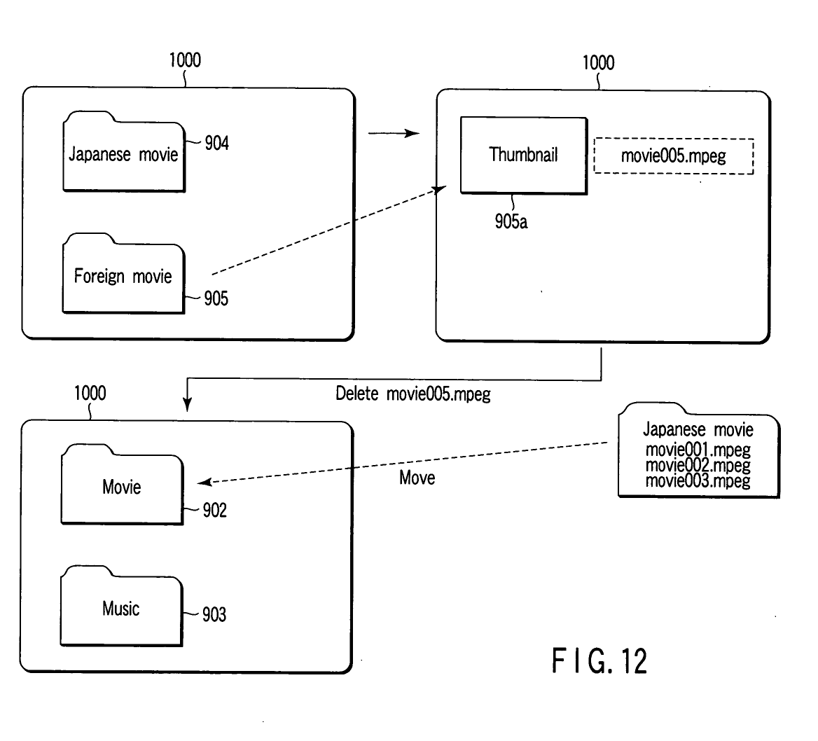

FIG. 12 shows the case where the foreign movie folder 905 included in the menu 1000 shown in FIG. 9B is clicked and the thumbnail 905a is displayed. Movie005.mpeg is displayed as a file name on one side of the thumbnail or under the thumbnail. Let us assume that the user operates the cursor to select the file of movie005.mpeg and operate the delete key. In response to this, the file of movie005.mpeg is deleted. In the case shown in FIG. 12, the foreign movie folder 905 becomes empty. At the same hierarchical level as the foreign movie folder 905, the Japanese movie folder 904 exists in addition to the foreign movie folder 905.

In this case, the file of movie001.mpeg, the file of movie002.mpeg and the file of movie003.mpeg are moved from the Japanese movie folder 904 to the higher-level movie folder 902. As a result, the foreign movie folder 905 and the Japanese movie folder 904 become unnecessary and are therefore deleted.

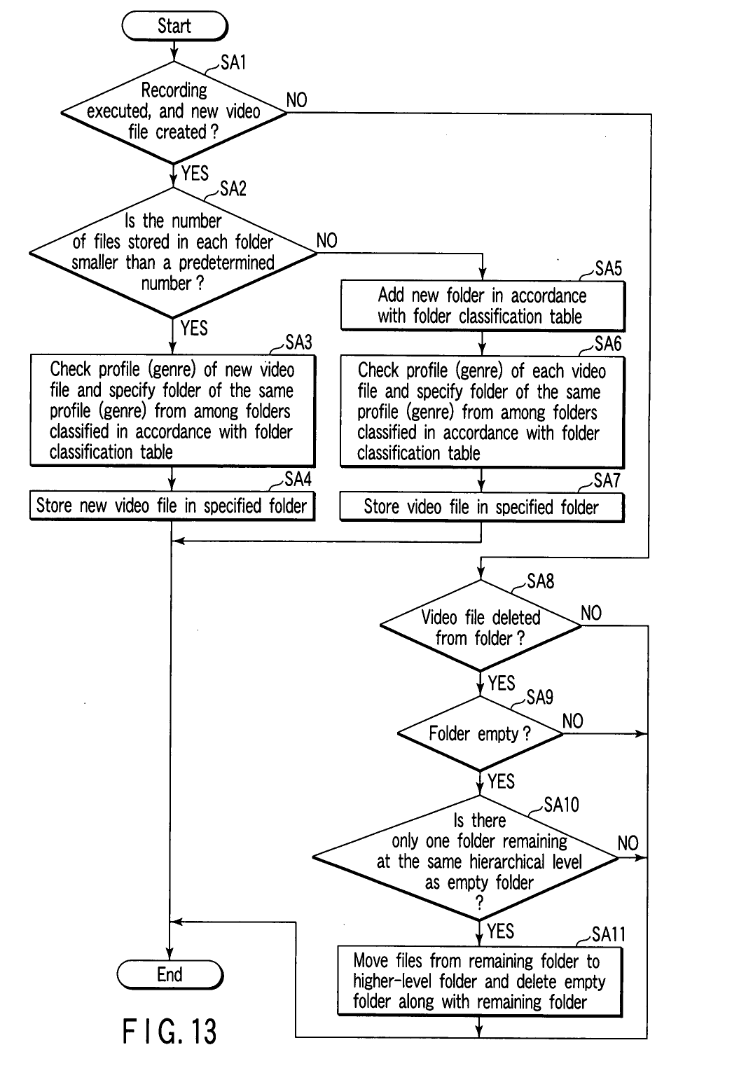

The flowchart in FIG. 13 illustrates the above-mentioned operations, including the creation of new folders and the deletion of existing folders. In FIG. 13, Steps SA1 to SA4 illustrate a routine executed when the creation of new folders and the deletion of existing folders are unnecessary. Steps SA5 to SA7 illustrate a routine executed for the addition of folders. Steps SA8 to SA11 illustrate a routine executed for the deletion of folders.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video library management apparatus comprising:
a storage section including a plurality of folders, each of which stores files;
a folder management section configured to manage the folders of the storage section; and
a library management section configured to cause the folder management section to classify and manage the folders based on a folder classification table having a hierarchical structure, the library management section adding a new folder when each of the folders contains more than a predetermined number of files.

2. The video library management apparatus according to claim 1, wherein the library management section includes a processing section configured to delete a folder when this folder becomes empty and to edit folder arrangement of the folder classification table.

3. The video library management apparatus according to claim 1, wherein the storage section includes a hard disk drive.

4. The video library management apparatus according to claim 1, wherein the library management section includes a file number setting processing section configured to display a menu used for determining how many files are stored in the folders.

5. The video library management section according to claim 1, wherein the library management section classifies the folders based on genres and further classifies lower-level folders based on sub genres.

6. A video library management method for use in an apparatus comprising: (i) a storage section including a plurality of folders, each of which stores files; (ii) a folder management section configured to manage the folders of the storage section; and (iii) a control section configured to perform library management, said method comprising:
causing the folder management section to classify and manage the folders based on a folder classification table having a hierarchical structure; and
adding a new folder at a lower hierarchical level when each of the folders contains more than a predetermined number of files.

7. The video library management method according to claim 6, further comprising:
deleting a folder when this folder becomes empty and editing folder arrangement of the folder classification table.

8. The video library management method according to claim 6, further comprising:
displaying a menu in response to a predetermined operation signal so as to determine how many files should be stored in the folders.

9. The video library management method according to claim 6, further comprising:
classifying the folders based on genres and further classifying lower-level folders based on sub genres.

10. The video library management method according to claim 6, further comprising:
automatically creating a lower-level folder when the folders contain more than a predetermined number of files; and
moving a file to the lower-level folder from a higher-level folder in response to automatic creation of the lower-level folder.

11. The video library management method according to claim 6, further comprising:
deleting a first folder when this first folder becomes empty; and
moving a file from a second folder, which is at an equivalent hierarchical level to that of the first folder, to a higher-level folder when the folder arrangement is edited based on the folder classification table.
